(19) United States
(12) Patent Application Publication
(10) Pub. No.: US 2021/0289911 A1
(43) Pub. Date: Sep. 23, 2021

(54) NAIL PRINTER

(71) Applicant: RICOH COMPANY, LTD., Tokyo (JP)

(72) Inventors: Takenori SUENAGA, Tochigi (JP); Masahide KOBAYASHI, Kanagawa (JP); Mitsunobu MORITA, Shizuoka (JP); Soh NOGUCHI, Kanagawa (JP); Takashi OKADA, Kanagawa (JP); Tatsuki YAMAGUCHI, Kanagawa (JP)

(21) Appl. No.: 17/180,922

(22) Filed: Feb. 22, 2021

(30) Foreign Application Priority Data
Mar. 19, 2020 (JP) 2020-049251
Jan. 15, 2021 (JP) 2021-005199

(51) Int. Cl. A45D 29/00; A45D 29/04; A45D 34/04; B41J 3/407; B41J 11/00

(52) U.S. Cl. CPC A45D 29/00; A45D 29/004; A45D 29/04; A45D 2200/205; B41J 3/4073; B41J 11/00212; A45D 2029/005; A45D 34/04

(57) ABSTRACT

A nail printer is provided. The nail printer includes a discharger, an irradiator, and an irradiation intensity variator. The discharger is configured to discharge an active energy ray curable composition to a nail by an inkjet method. The irradiator is configured to irradiate the nail with an active energy ray. The irradiation intensity variator is configured to vary an irradiation intensity of the active energy ray radiated from the irradiator.

### CROSS-REFERENCE TO RELATED APPLICATIONS

This patent application is based on and claims priority pursuant to 35 U.S.C. § 119(a) to Japanese Patent Application Nos. 2020-049251 and 2021-005199, filed on Mar. 19, 2020 and Jan. 15, 2021, respectively, in the Japan Patent Office, the entire disclosure of each of which is hereby incorporated by reference herein.

### BACKGROUND

### Technical Field

The present disclosure relates to a nail printer.

### Description of the Related Art

As a method for decorating nails, gel nails are known. Gel nails are made by applying an active energy ray curable ink having fluidity (“nail material”) to nails and irradiating the nail material with ultraviolet rays or visible light to cure the nail material by a photopolymerization reaction.

As another example, a method of preparing artificial nails using an inkjet method has been proposed.

As another example, a technique of discharging an ultraviolet curable ink to nails by an inkjet method and irradiating the ink with ultraviolet rays to cure the ink has been proposed.

### SUMMARY

In accordance with some embodiments of the present invention, a nail printer is provided. The nail printer includes a discharger, an irradiator, and an irradiation intensity variator. The discharger is configured to discharge an active energy ray curable composition to a nail by an inkjet method. The irradiator is configured to irradiate the nail with an active energy ray. The irradiation intensity variator is configured to vary an irradiation intensity of the active energy ray radiated from the irradiator.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a diagram for explaining profiles for varying the irradiation intensity;

FIG. 2 is a schematic diagram illustrating a nail printer according to an embodiment of the present invention;

FIG. 3 is a schematic diagram illustrating a nail printer according to an embodiment of the present invention;

FIG. 4 is a schematic diagram illustrating a removing device according to an embodiment of the present invention;

FIG. 5 is a schematic diagram illustrating a nail printer according to an embodiment of the present invention;

FIG. 6 is a schematic diagram illustrating a nail printer according to an embodiment of the present invention;

FIG. 7 is a schematic diagram illustrating a file according to an embodiment of the present invention;

FIG. 8 is a schematic diagram illustrating a nail printer according to an embodiment of the present invention;

FIG. 9 is a schematic diagram illustrating a moisturizer applicator according to an embodiment of the present invention; and

FIG. 10 is a functional block diagram of the nail printer according to an embodiment of the present invention.

The accompanying drawings are intended to depict example embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

In accordance with some embodiments of the present invention, a nail printer is provided that is capable of safely forming a cured product of a composition, having excellent durability, on nails by irradiating the composition with an active energy ray.

Hereinafter, the nail printer according to some embodiments of the present invention is described with reference to the drawings. Incidentally, it is to be noted that the following embodiments are not limiting the present invention and any deletion, addition, modification, change, etc. can be made within a scope in which person skilled in the art can conceive including other embodiments, and any of which is included within the scope of the present invention as long as the effect and feature of the present invention are demonstrated.

### First Embodiment

A nail printer according to the present embodiment includes: a discharger configured to discharge an active energy ray curable composition to a nail by an inkjet method; an irradiator configured to irradiate the nail with an active energy ray; and an irradiation intensity variator configured to vary an irradiation intensity of the active energy ray radiated from the irradiator.

The nail printer of the present embodiment, which includes the discharger configured to discharge the active energy ray curable composition by an inkjet method, may also be referred to as an inkjet recording apparatus or an image forming apparatus.

The nail printer of the present embodiment is capable of safely forming a cured product of a composition, having excellent durability, on nails by irradiating the composition with an active energy ray. The nail printer has eliminated processes for applying a base or coat layer, resulting in reduction of the number of processes in forming the cured product.

The nail printer may further include a mechanism for attaching a nail-shaped recording medium, which may be made of plastic, to a nail and may discharge the composition to the recording medium.

### Discharger

The discharger of the present embodiment discharges an active energy ray curable composition (hereinafter may be simply referred to as “composition”) to a nail by an inkjet method.

The discharger of the present embodiment may be, but is not limited to, a liquid discharge head (may also be referred to as “inkjet head” or “print head”) having a plurality of nozzles, or a head unit having one or more liquid discharge heads.

The method by which the discharger discharges the active energy ray curable composition is not particularly limited and may be of a continuous injection type and an on-demand type. Specific examples of the on-demand type include, but are not limited to, piezo type, thermal type, and electrostatic type.

The inkjet recording method performed by the discharger of the present embodiment may be either a line method or a serial method. In the serial method, the head is moved to discharge the active energy ray curable composition onto a recording medium that moves intermittently according to the width of the liquid discharge head. The resulted nail-shaped cured product may be either two-dimensional, two-and a-half-dimensional, or three-dimensional.

In the present embodiment, preferably, the nail printer employs a serial method. More preferably, the nail printer employs a serial method in which both the discharger and the irradiator are movable. In this case, discharging and curing of the active energy ray curable composition are facilitated, and production of a laminate becomes easier. In the present embodiment, the discharger and the irradiator may be arranged adjacent to each other.

### Irradiator

The irradiator may be an ultraviolet irradiator. The ultraviolet irradiator is strongly desired to be mercury-free for environmental protection. Replacement with GaN-based semiconductor ultraviolet light emitting devices is very useful both industrially and environmentally. In addition, ultraviolet light emitting diodes (UV-LED) and ultraviolet laser diodes (UV-LD) are preferably used as ultraviolet light sources since they are compact, long-life, highly-efficient, and low-cost.

Among these, for safety, energy saving, and miniaturization of the apparatus, ultraviolet light emitting diodes (UV-LED) that emit ultraviolet rays having a peak wavelength in a range of from 285 to 405 nm are preferred. Preferably, the active energy ray radiated from the irradiator has a peak wavelength in a range of from 365 to 405 nm.

The irradiation intensity of the active energy ray radiated from the irradiator may be adjusted within a range that is not harmful to the human body, for example, within a range of from 10 to 500 mJ/cm².

Preferably, the active energy ray radiated from the irradiator is ultraviolet rays. In addition, those capable of giving energy required to proceed a polymerization reaction of polymerizable components included in the composition may be used, such as electron beams, α-rays, β-rays, γ-rays, and X-rays.

Irradiation Intensity Variator

The irradiation intensity variator is not particularly limited as long as it is capable of varying the irradiation intensity by the irradiator. For example, the irradiation intensity can be varied by a control unit. A configuration of the control unit is described later.

During a polymerization reaction, the temperature of the composition is raised due to the heat of reaction. The larger the intensity of the active energy ray, the more the cleavage of the polymerization initiator in the active energy ray curable composition is accelerated, the greater the amount of reaction per unit time, and the higher the temperature of the composition. When the temperature of the composition is high, there is a risk of skin damage or burns in some cases.

In the present embodiment, since the irradiation intensity by the irradiator is variable, the risk of skin damage or burns can be reduced, and nail-shaped cured products can be safely produced.

Conditions under which the irradiation intensity variator varies the irradiation intensity can be changed as appropriate. For example, the irradiation intensity may be varied depending on the time lapsed after the irradiator starts irradiation. In this case, the irradiation intensity may be controlled to become smaller as the irradiation time becomes longer. In addition, the irradiation intensity may be varied according to the temperature of the nail and the periphery of the nail. In this case, the irradiation intensity may be controlled to become smaller as the temperature of the nail and the periphery of the nail becomes higher. Such a control may be performed in either a stepwise manner or a continuous manner.

Furthermore, the irradiation intensity may be varied depending on the compositional condition of the active energy ray curable composition. For example, in a case in which the composition contains a polymerizable compound (e.g., polyfunctional monomer) that is easy to get high in temperature through a polymerization reaction and/or a polymerization initiator (e.g., a cleavage-type initiator sensitive at from 365 to 405 nm), the irradiation intensity may be varied when the proportion of the polymerization initiator in the composition exceeds 10% by mass.

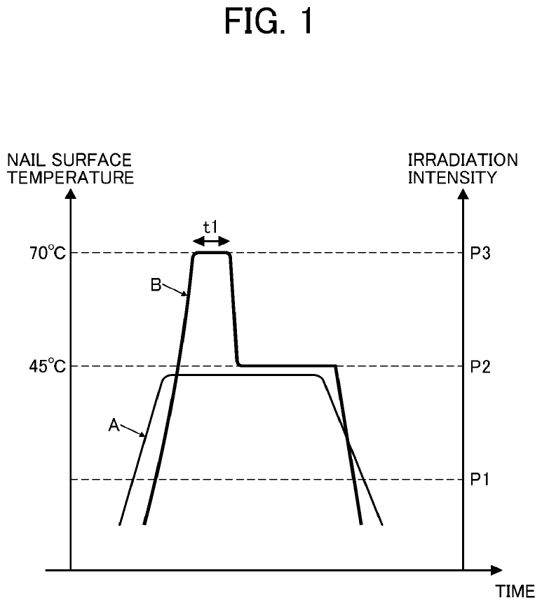

Procedures for varying the irradiation intensity are described below with reference to FIG. 1. In the graph illustrated in FIG. 1, the horizontal axis represents time, the vertical axis represents the nail surface temperature and the irradiation intensity, and two examples (profiles A and B) are presented. Here, P1 represents the minimum irradiation intensity required for curing, P2 represents an irradiation intensity at when the temperature of the nail surface becomes about 45° C., and P3 represents an irradiation intensity at when the temperature of the nail surface becomes about 70° C.

In the profile A, the irradiation intensity exceeds P1 but does not exceed P2. With this profile, the amount of light required for curing is secured even when the irradiation intensity is small, and it becomes easier to prevent burns. Thus, one example procedure involves controlling the temperature of the nail surface so as not to exceed 45° C.

In the profile B, the irradiation intensity exceeds P2, but the irradiation time with the irradiation intensity P3 is shortened as much as possible. The irradiation time (t1) with the irradiation intensity P3 may be set to, for example, 0.5 seconds or less. It is generally considered that the skin is instantly damaged at about 70° C., specifically the skin starts to be damaged in 1 second at 70° C. Therefore, it is preferable that the irradiation time with an irradiation intensity with which the temperature of the nail surface becomes about 70° C. be as short as possible below 1 second. With this profile, not only burns can be prevented but also the irradiation time can be shortened. Thus, one example procedure for varying the irradiation intensity involves shortening the irradiation time with an irradiation intensity with which the temperature of the nail surface becomes about 70° C.

The procedure for varying the irradiation intensity is not limited to those described above. Another procedure involves shortening the irradiation time with an irradiation intensity exceeding P2 but less than P3. In the profile B, the irradiation time with P2 is provided after that with P3, but the irradiation time with P2 is not necessary.

### Jig

Preferably, the nail printer of the present embodiment includes a jig configured to fix a finger. The configuration of the jig is not particularly limited as long as the jig is capable of fixing a nail so that the nail faces the discharger. The shape, number, and arrangement position can be changed as appropriate. For example, the jig may be configured to automatically move a finger from which an artificial nail has been removed by a removing device, for replacement with another artificial nail, to the discharge position.

The jig may be configured to fix about 1 to 10 fingers or toes. The fingers to be fixed may be either of one person or of a plurality of persons. In either case in which the fingers to be fixed are of one person or of a plurality of persons, the jig may be configured to fix either target fingers (to which the composition is to be discharged or from which the cured product is to be removed) or non-target fingers (to which the composition is not to be discharged or from which the cured product it not to be removed). The jig may also be configured to fix both of target fingers and non-target fingers. In this case, the movement of the fingers or the entire hand can be minimized as compared with the case where only the target fingers for discharging and removing are fixed, which contributes to removal efficiency and aesthetics as well as prevention of misalignment.

The use of the jig for fixing fingers prevents the occurrence of misalignment caused by the movement of fingers at when the active energy ray curable composition is discharged.

In fixing a finger with the jig, the user may directly move the jig, or the nail printer may move the jig to fix the finger.

### Temperature Measuring Device

The nail printer of the present embodiment may include a temperature measuring device that measures the temperature of the nail in a non-contact manner. In this case, preferably, the irradiation intensity variator varies the irradiation intensity according to the temperature measured by the temperature measuring device.

Non-contact-type temperature measuring devices are not particularly limited, but those having a spot diameter of 1 cm² or less with respect to the distance from the nail when installed are preferred. The number and arrangement thereof can be changed as appropriate. The measurement of temperature may be performed either continuously from the time when the power is turned on to the time when the power is turned off or during the time period required for determining the irradiation intensity.

How to use the temperature measuring device is not limited to the above and can be appropriately changed. For example, the temperature measuring device may be used to determine a boundary between the nail and the skin. When the boundary between the nail and the skin is determined based on the temperature measured by the temperature measuring device, the discharger preferably discharges the active energy ray curable composition to a position which is determined to be the position of the nail.

In this case, an artificial nail can be more accurately produced without protruding from the nail. In addition to reduce the amount of the active energy ray curable composition protruding from the nail, the amount of dirt in the apparatus can also be reduced.

The temperature measuring device may also be used to grasp the presence or absence of the cured product and the position of the cured product when removing the cured product from the nail surface.

### Imaging Device

The nail printer of the present embodiment may include an imaging device such as a camera. The imaging device is not particularly limited, but those small in size are preferred. Further, those capable of taking three-dimensional photographs are preferred.

How to use the imaging device can be changed as appropriate. Preferably, the position of the nail is determined based on an image captured by the imaging device, and the discharger discharges the active energy ray curable composition to a position which is determined to be the position of the nail. In this case, an artificial nail can be produced more accurately.

The arrangement position of the imaging device can be changed as appropriate. For example, the imaging device may be arranged adjacent to the irradiator. In this case, in a serial-type head, the imaging device is allowed to scan together with the discharger and the irradiator. Furthermore, in this case, there are advantages that the aesthetics are improved and portions other than the nail are prevented from becoming dirty.

The imaging device is not limited to be arranged so as to be able to scan together with the discharger and the irradiator and may be fixed inside the apparatus.

Preferably, the discharger discharges the active energy ray curable composition to a position which is determined to be the position of the nail based on the image of the nail captured by the imaging device. In this case, the active energy ray curable composition can be discharged more accurately, and an artificial nail can be produced more accurately.

The imaging device may also be used to grasp the presence or absence of the cured product and the position of the cured product when removing the cured product from the nail surface.

### Active Energy Ray Curable Composition

The active energy ray curable composition may be any composition that is curable by the active energy ray radiated from the irradiator.

Preferred examples of the active energy ray curable composition include, but are not limited to, those curable in a short time as much as possible, for example, those curable within 2 minutes of irradiation.

For safety, it is preferable that the active energy ray curable composition have a stimulation index (“SI”) of 3.0 or less, measured according to a skin sensitization test. To adjust the SI to 3.0 or less, for example, a monomer having an SI of 3.0 or less, such as diethylene glycol dimethacrylate, may be selected.

The SI can be determined by the LLNA (Local Lymph Node Assay) method defined in the OECD (Organisation for Economic Cooperation and Development) test guideline No. 429.

The active energy ray curable composition of the present embodiment may contain, for example, a polymerizable compound, a polymerization initiator, a colorant such as pigment and dye, a metal powder, an inorganic filler such as calcium carbonate, talc, silica, alumina, and aluminum hydroxide, a flame retardant, an organic filler, an antioxidant, a polymerization inhibitor, a defoamer, a coupling agent, a leveling agent, and/or a rheology control agent.

### Polymerizable Compound

The active energy ray curable composition of the present embodiment may contain a polymerizable compound that is curable by the active energy ray. The polymerizable compound can be appropriately selected, and examples thereof include known monomers and oligomers.

### Polymerization Initiator

The active energy ray curable composition of the present embodiment may contain a polymerization initiator. The polymerization initiator is any material capable of generating active species, such as radical and cation, by the action of the active energy ray, to cause the polymerizable compound (e.g., monomer and oligomer) to initiate a polymerization. As such a polymerization initiator, known radical polymerization initiators, cationic polymerization initiators, and base generators can be used singly or in combination of two or more. Among them, photoradical polymerization initiators are preferred. Preferably, the proportion of the polymerization initiator is from 5% to 20% by mass with respect to the total mass (100% by mass) of the composition to achieve a sufficient curing speed.

Specific examples of the radical polymerization initiators include, but are not limited to, aromatic ketones, acylphosphine oxide compounds, aromatic onium salt compounds, organic peroxides, thio compounds (e.g., thioxanthone compounds and thiophenyl-group-containing compounds), hexaaryl biimidazole compounds, ketoxime ester compounds, borate compounds, azinium compounds, metallocene compounds, active ester compounds, carbon-halogen-bond-containing compounds, and alkylamine compounds.

In addition, a polymerization accelerator (sensitizer) may be used in combination with the polymerization initiator. Specific examples of the polymerization accelerator include, but are not limited to, amine compounds, such as trimethylamine, methyldimethanolamine, triethanolamine, p-diethyl aminoacetophenone, ethyl p-dimethylaminobenzoate, 2-ethylhexyl p-dimethylaminobenzoate, N,N-dimethylbenzylamine, and 4,4′-bis(diethylamino)benzophenone. The content of the polymerization accelerator is determined according to the type and amount of the polymerization initiator used in combination.

### Colorant

The active energy ray curable composition of the present embodiment may contain a colorant. Examples of the colorant include pigments and dyes that impart colors such as black, white, magenta, cyan, yellow, green, and orange, or metallic colors such as gold and silver. The content of the colorant in the composition can be appropriately determined depending on a desired color density and dispersibility in the composition. Preferably, the proportion of the colorant in 100% by mass of the composition is from 0.1% to 20% by mass. The active energy ray curable composition may be free of colorant to be colorless and transparent.

Examples of the pigments include inorganic pigments and organic pigments. Two or more of these pigments can be used in combination.

Specific examples of the inorganic pigments include, but are not limited to, carbon blacks (i.e., C.I. Pigment Black 7) such as furnace black, lamp black, acetylene black, and channel black; iron oxides; and titanium oxides.

Specific examples of the organic pigments include, but are not limited to, azo pigments (e.g., insoluble azo pigments, condensed azo pigments, azo lakes, and chelate azo pigments), polycyclic pigments (e.g., phthalocyanine pigments, perylene and perinone pigments, anthraquinone pigments, quinacridone pigments, dioxane pigments, thioindigo pigments, isoindolinone pigments, and quinophthalone pigments), dye chelates (e.g., basic dye chelates and acid dye chelates), dye lakes (e.g., basic dye lakes and acid dye lakes), nitro pigments, nitroso pigments, aniline black, and daylight fluorescent pigments. The composition may contain a luminous paint component, a photoluminescent component, and/or an inorganic filler that emits a metallic color, in addition to the pigment or in place of the pigment.

The composition may further contain a dispersant for improving dispersibility of the pigment. Examples of the dispersant include, but are not limited to, polymeric dispersants commonly used to prepare pigment dispersions.

Examples of the dyes include, but are not limited to, acid dyes, direct dyes, reactive dyes, and basic dyes. Two or more of these dyes can be used in combination.

### Organic Solvent

The active energy ray curable composition may contain an organic solvent. However, it is preferable that the active energy ray curable composition contain no organic solvent. When the composition contains no organic solvent, in particular, when the composition is free of VOC (volatile organic compound), a higher degree of safety is provided at sites where the composition is being handled while environment pollution is prevented. Here, the organic solvent refers to a general non-reactive organic solvent, such as ether, ketone, xylene, ethyl acetate, cyclohexanone, and toluene, which should be distinguished from reactive monomers. When the composition is stated to contain no organic solvent, it means that the composition does not “substantially” contain an organic solvent. In this case, the proportion of the organic solvent in the composition is preferably less than 0.1% by mass.

### Nail Printer

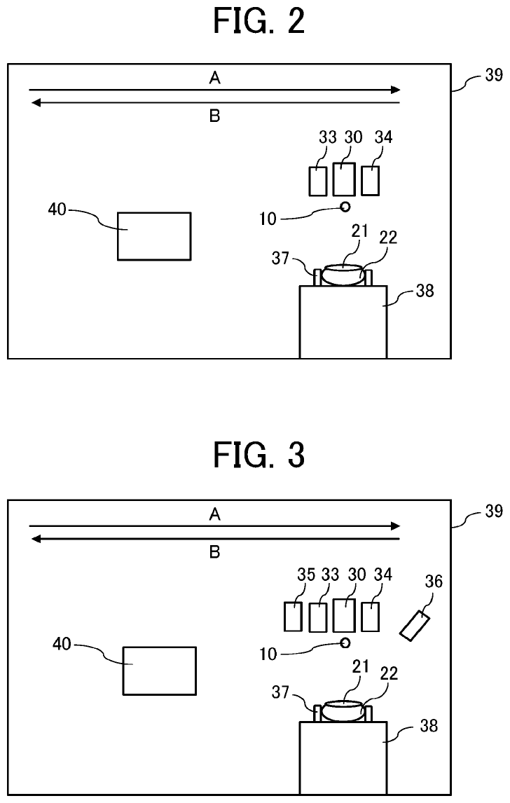

FIG. 2 is a schematic diagram illustrating a nail printer of the present embodiment. A nail printer 39 of the present embodiment includes a head unit 30 as a discharger in which inkjet heads are arranged. The head unit 30 is movable in the direction indicated by arrows A and B in FIG. 1 and performs reciprocating scanning.

The head unit 30 discharges an active energy ray curable composition 10 to a nail 21. The head unit 30 includes a plurality of inkjet heads. The inkjet heads discharge inks having different colors.

Irradiators 33 and 34 are disposed adjacent to the head unit 30 and together perform scanning. In the present embodiment, the head unit 30 discharges the active energy ray curable composition 10 to the nail 21 of a finger 22 fixed to a jig 37, and the irradiators 33 and 34 radiates ultraviolet rays. As a result, a cured product as an artificial nail having excellent durability is formed.

In another embodiment, the head unit 30 and the irradiators 33 and 34 are mounted on a carriage, and the carriage is caused to scan.

It is preferable that the finger 22 is fixed with the jig 37 so as not to move largely. By fixing the finger 22 with the jig 37 so as not to move, misalignment with the discharge position of the composition is avoided. It can also be stated either that the finger 22 is fixed to the jig 37 or that the finger is fixed to a stage 38.

The fixed position of the jig 37 may be manually adjusted by the user to fit to the finger 22, or automatically adjusted through a nail information detection control performed by a nail information detection controller of the control unit of the nail printer. How the printer automatically adjusts the fixed position can be changed as appropriate. For example, the nail information detection control may involve detecting insertion of the finger 22 in the printer or placement of the finger 22 on the stage 38, detecting the size and shape of the finger 22, and moving the jig 37 according to the shape of the finger 22 for fixation.

The resulting cured product may be a laminated body. A lower layer is formed by discharging the active energy ray curable composition 10 from the head unit 30 and irradiating the composition with an active energy ray for solidification. After that, an upper layer is formed on the lower layer by discharging the active energy ray curable composition 10 from the head unit 30 and irradiating the composition with an active energy ray for solidification. The cured product is produced by repeating these processes according to the number of times of lamination. These processes may be repeatedly performed while lowering the stage 38.

The number of the head unit 30 is not only one, as illustrated in FIG. 2, and may be two or more. The number of the irradiators is not limited to two, as illustrated in FIG. 2, and may be one or two or more. In a case where the number of the irradiator is two, in reciprocating scanning, discharge of ink and irradiation with light can be performed during both forward and backward movements in the reciprocating scanning.

The printer illustrated in FIG. 2 includes a removing device 40. However, the printer of the present embodiment needs not necessarily include the removing device 40. (The same applies to FIGS. 3 and 5). The removing device 40 is schematically illustrated in FIG. 2, and the scale, size, arrangement, etc. thereof are not limited to those as shown in the drawing and can be changed as appropriate. The printer having the removing device 40 is advantageously capable of automatically removing a cured product. Specific examples of the removing device 40 are described later.

In the present embodiment, the irradiation intensity variator of the control unit varies the irradiation intensity. For example, the irradiation intensity and the irradiation time are set in advance, and the irradiation intensity is controlled under the set conditions.

FIG. 3 is a schematic diagram illustrating the nail printer according to another embodiment of the present invention. The nail printer of the present embodiment includes a camera 35 as an imaging device and a thermometer 36 as a non-contact temperature measuring device.

The camera 35 is scanned together with the head unit 30 and the irradiators 33 and 34 to capture an image of the nail 21. The control unit determines the position of the nail 21 based on the image of the nail 21. The head unit 30 discharges the active energy ray curable composition 10 to a position which is determined to be the position of the nail 21.

The thermometer 36 measures the temperature of the nail 21 and the periphery thereof in a non-contact manner. The control unit discriminates the position of the nail 21 and other positions based on the temperature measured by the thermometer 36. The head unit 30 discharges the active energy ray curable composition 10 to a position which is determined to be the position of the nail 21.

In the present embodiment, the active energy ray curable composition 10 can be accurately discharged to the nail 21, thus providing an artificial nail with higher quality.

The irradiation intensity by the irradiators 33 and 34 may be varied according to the temperature of the surface of the nail 21 measured by the thermometer 36. This configuration prevents the temperature of the finger 22 from rising too high and prevents damage to the skin.

The printer of the present embodiment is not limited to that including both the camera 35 and the thermometer 36, any may include at least one of the camera 35 and the thermometer 36.

### Second Embodiment

Next, a nail printer according to another embodiment of the present invention is described in detail below. Hereinafter, descriptions of the same items as those in the above embodiments will be appropriately omitted.

### Removing Device

The nail printer of the present embodiment includes a removing device configured to remove a cured product formed on a nail.

The removing device may include a removing member containing a removing agent (e.g., remover) and may be configured to bring the removing member into contact with the nail to remove the cured product formed on the nail. The operation of the removing device to remove the cured product may be referred to as a removing operation.

Conventionally, in removing cured products formed on nails, such as gel nails, it has been necessary for a nail technician to apply a remover (removing agent) having a strong odor to the nails and wipe it off or scrape it after a while. On the other hand, the nail printer of the present embodiment automatically removes the cured product, reducing of human labor. The nail printer may be configured to allow the user to select whether or not to remove the cured product using the removing device.

The cured product to be removed by the removing device is not particularly limited. Examples thereof include cured products formed as gel nails, artificial nails (cured products) formed according to embodiments of the present invention, and other types of cured products.

Examples of the removing member include, but are not limited to, wiping members. It is easy to remove the cured product formed on the nail by applying a wiping member impregnated with a removing agent to the nail and wiping the cured product with the wiping member.

The material of the wiping member is not particularly limited, but non-woven fabrics are preferred. Specific examples of the non-woven fabrics include, but are not limited to, semi-synthetic fibers such as cupro, and synthetic fibers such as PET (polyethylene terephthalate), PP (polypropylene), PE (polyethylene), and Ny (nylon). Specific examples of the non-woven fabrics further include, but are not limited to, liquid absorptive materials such as porous bodies made of PVA (polyvinyl alcohol), woven cloth, and knitted cloth.

Examples of the removing agent include, but are not limited to, known nail polish removers.

The removing device of the present embodiment may include a pressing member that brings the removing member into contact with the nail. The removing operation may be performed by bringing the removing member into contact with the nail by the pressing member. The removing operation may be performed by relatively moving the nail and the removing member pressed against the nail.

The removing device may be either fixed or movable inside the nail printer. Alternatively, a conveying device configured to move the removing device may be provided in the nail printer.

How to determine whether or not the removing device performs the removing operation or on which position on the nail the removing operation is to be performed can be changed as appropriate. For example, the removing operation may always be performed before discharge of the composition, or the removing operation may be performed in a specific case. The removing operation may be performed either on the entire nail or on a part of the nail. For example, the presence or absence or of the cured product on the nail surface or the position of the cured product may be detected through a nail information detection control performed by a nail information detection controller of the control unit of the nail printer. For example, the removing operation may be performed only when the imaging device, the temperature measuring device, or the like determines that the cured product is present on the nail. Further, the removing operation may be focused on the position where the presence of cured product is detected.

As will be described later, the removing device may be provided with a file. In a case in which the removing operation is insufficient to completely remove the cured product, the nail may be polished with the file.

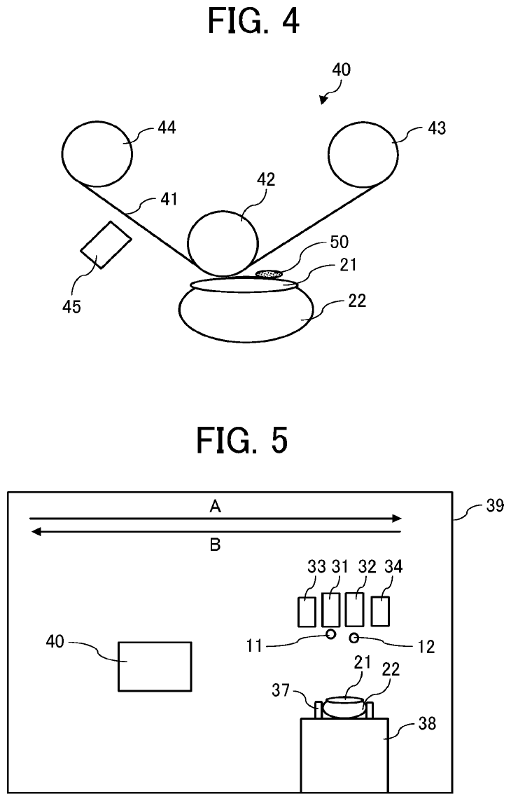

An example of the removing device of the present embodiment is illustrated in FIG. 4. In this example, the removing member is a wiping member. The removing device 40 includes a wiping member 41, a pressing roller 42, a supply roller 43, a take-up roller 44, and a supply device 45.

The pressing roller 42 presses the wiping member 41 against the nail 21 using a biasing member such as a spring to bring the wiping member 41 into contact with the nail 21. The pressing force may be arbitrarily adjusted by the control unit.

The supply roller 43 sends out the wiping member 41, and the take-up roller 44 winds up the wiping member 41. The tension of the wiping member 41 stretched between the supply roller 43 and the take-up roller 44 can be adjusted by adjusting the send-out amount by the supply roller 43 and the take-up amount by the take-up roller 44. The supply roller 43 and the take-up roller 44 may be hereinafter collectively referred to as a wiping member conveyer.

The wiping member 41 may be a non-woven fabric. The supply device 45 supplies a remover (removing agent) to the wiping member 41 to make the wiping member 41 contain and the remover. When to supply the remover can be changed as appropriate.

After the wiping member 41 containing the remover has been brought into contact with the nail 21, a wiping operation is performed. After the pressure of the pressing roller 42 is adjusted and the tension of the wiping member 41 is adjusted by the wiping member conveyer, the wiping operation is performed to remove cured product 50 on the nail 21. The wiping operation is performed by relatively moving the nail 21 and the wiping member 41 pressed against the nail 21.

### Third Embodiment

The nail printer of the present invention may be used to form an artificial nail. In the present embodiment, a case in which an artificial nail is formed on a nail is described.

In the present embodiment, the active energy ray curable composition is referred to as an artificial nail composition. The artificial nail composition of the present embodiment is used to form an artificial nail by being applied onto a human or animal nail or on another artificial nail and cured by irradiation with an active energy ray. The artificial nail formed of the artificial nail composition can be removed using an organic solvent or the like.

The artificial nail of the present embodiment refers to a layer formed on a human or animal nail or on another artificial nail for the purpose of beautification and/or protection. Examples of the other artificial nails include resin substrates (false nails) having an arbitrary shape for the purpose of beautifying and/or protecting the nail. In the present embodiment, “human and animal nails and other artificial nails” may be simply and collectively referred to as “nails”.

The artificial nail obtained in the present embodiment is not particularly limited in shape and can be formed into a desired shape. The artificial nail may be formed so as to cover the surface of the nail, formed only on a part of the nail, or formed into a shape larger than the nail by using a nail form for extension of the nail.

In the present embodiment, the thickness of the artificial nail can be controlled by way of application. The thickness of the entire artificial nail is not particularly limited as long as it is within a general thickness range, but it is preferably in the range of from 10 to 2,000 μm for durability and removability.

How to control the thickness of the artificial nail can be changed as appropriate. For example, the control unit of the nail printer may control the discharge amount of the discharger to adjust the thickness of the artificial nail to a thickness specified by the user. Alternatively, the nail information detection controller of the control unit of the nail printer may perform the nail information detection control to detect the thickness of the artificial nail at the time of or before the discharger discharges the composition and to adjust the thickness of the artificial nail to a predetermined thickness.

The artificial nail may have a structure in which, from the side closer to the nail, a primer layer, a base layer, a color layer, and a top layer are laminated.

The primer layer is configured as a layer between the nail and the base layer for improving adhesion therebetween when the adhesion of the base layer to the nail is insufficient.

The base layer is configured as a layer between the nail and the color layer to improve adhesion therebetween and prevent color transfer to the nail.

The color layer is configured as a layer containing a colorant.

The top layer is configured as the outermost layer to improve durability, glossiness, and aesthetics.

The nail printer of the present embodiment is capable of forming all of the primer layer, the base layer, the color layer, and the top layer. The nail printer may be configured to form either all of these layers or any one of these layers. From the viewpoint of safety, durability, and removability, the nail printer is preferably used to form a layer that contacts the nail.

For the purpose of imparting color, glossiness, and/or adhesion, the primer layer, base layer, color layer, and/or top layer may be formed on the upper layer (the surface of the artificial nail opposite to the nail) or the lower layer (the surface of the artificial nail closer the nail) of the artificial nail obtained in the present embodiment.

FIG. 5 is a schematic diagram illustrating the nail printer of the present embodiment. In the embodiment illustrated in FIG. 5, the nail printer includes an object forming head unit 31 and a support forming head unit 32 as dischargers. In the present embodiment, the object forming head unit 31 discharges a first composition 11, and the support forming head unit 32 discharges a second composition 12 different from the first composition 11.

The first composition 11 and the second composition 12 may be the active energy ray curable composition according to some embodiments of the present invention. The first composition 11 may be used to form a color layer, and the second composition 12 may be used to form a primer layer, a base layer, and a top layer.

Irradiators 33 and 34 are disposed adjacent to the head units 31 and 32 and together perform scanning. The head units 31 and 32 discharge the compositions 11 and 12 to the nail 21, and the irradiators 33 and 34 irradiate the compositions with active energy rays such as ultraviolet rays to the nail 21 to form a cured product.

In this example, the second composition 12 is discharged from the support forming head unit 32 and irradiated with active energy rays to be solidified to form a base layer. After that, the first composition 11 is discharged from the object forming head unit 31 to the base layer and irradiated with active energy rays to be solidified to form a color layer. An artificial nail is produced by repeating these processes multiple times. These processes are repeatedly performed while lowering the stage 38.

### Fourth Embodiment

Next, a nail printer according to another embodiment of the present invention is described in detail below. Hereinafter, descriptions of the same items as those in the above embodiments will be appropriately omitted.

The nail printer of the present embodiment includes a removing device equipped with a file. The removing device of the present embodiment may be further equipped with the above-described removing member in addition to the file. When the removing member is used in combination with the file, the order of removal by the file and removal by the removing member can be changed as appropriate, and either of them may be the first.

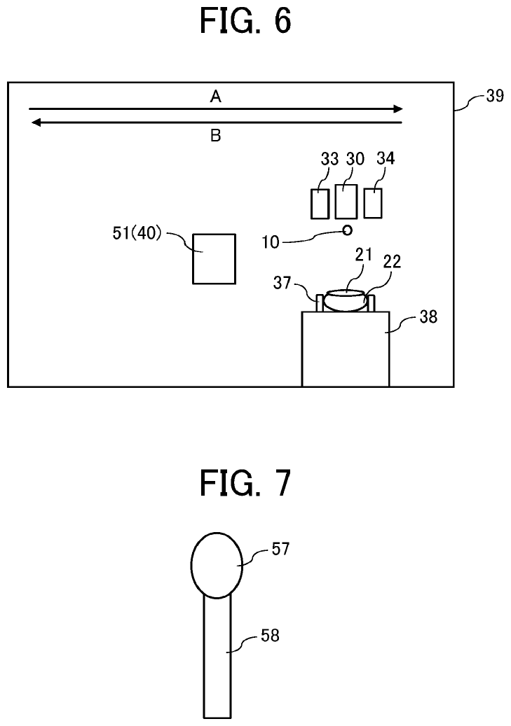

The present embodiment is described below with reference to FIG. 6. In FIG. 6, a file 51 is included in the removing device 40. The form, arrangement, etc. of the file 51 can be changed as appropriate. For example, as illustrated in FIG. 6, the file 51 may be fixed at a position close to the nail 21 and moved finely to scrape off the cured product. In this case, the stage 38 may be moved to the position of the file 51. Alternatively, the removing device 40 may be moved to the position of the nail 21, or the distance between the file 51 and the nail 21 may be changed. The file of the present embodiment may be movable to be arranged at an appropriate position according to the shape and position of the nail 21 or fixed at an approximate position.

The file 51 may be installed in place of the wiping member 41, the pressing roller 42, the supply roller 43, and the take-up roller 44 illustrated in FIG. 4. In this case, the distance between the file 51 and the nail 21 may be changed by a biasing member.

The type of file used in the present embodiment is not particularly limited, and may be made of paper such as cardboard, sponge-like material, metal such as steel and iron, or glass. For durability, the file is preferably made of metal or glass.

The shape of the file is not particularly limited and can be appropriately selected. For example, sheet-like files and sandpaper may be used. The file may have another shape or may be attached to another member.

Another example of the file is illustrated in FIG. 7. This file includes a file portion 57 attached to a support rod 58. The file portion 57 comes into contact with the cured product. The support rod 58 may be attached to a driver of a roller to allow the support rod 58 and the file portion 57 to rotate. This file may be used in place of the roller illustrated in FIG. 4.

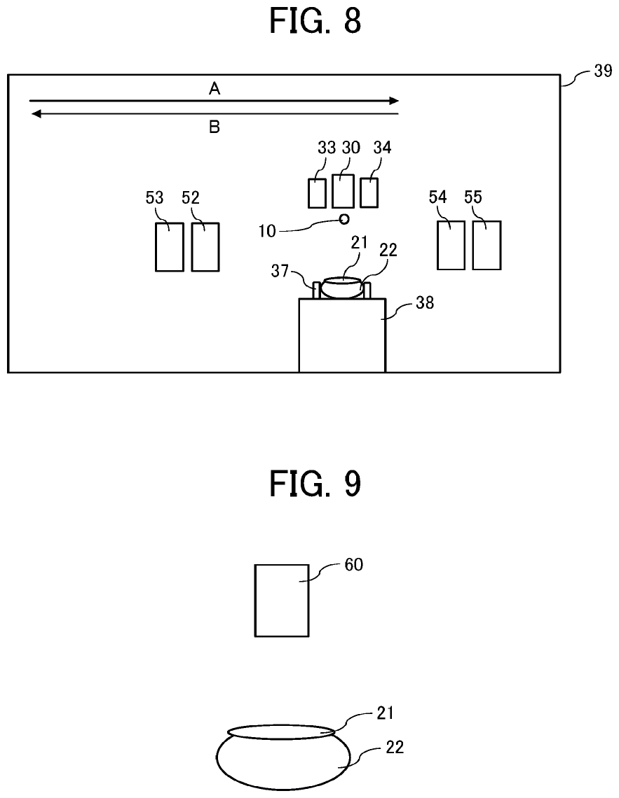

In the present embodiment, only a specific file may be used, or the type of file may be appropriately changed depending on the degree of abrading. A plurality of files may also be used, as illustrated in FIG. 8. In FIG. 8, the nail printer of the present embodiment includes files 52 to 55. These files are of different types. For example, one of them may be a file capable of abrading hard matter well, and another one of them may be a file capable of finely abrading a portion close to the nail surface. The use of a plurality of files makes it possible to efficiently abrade the cured product in a short time with reducing the risk of scraping the nail surface, which is advantageous.

The arrangement of the files 52 to 55 is not limited to that illustrated in FIG. 8 and can be changed as appropriate. Similar to the embodiment illustrated in FIG. 6, the files may be either fixed or movable inside the nail printer. The number of the files 52 to 55 can also be changed as appropriate.

In the present embodiment, files having a grit number (G) of 80G to 280G are preferred. It is preferable that one or more of files within this range be used, and files with 150G are particularly preferred. Here, “G” represents the grit number.

Files with 80G to 100G are capable of well abrading cured products with high hardness but is likely to abrade the surface of the nail together. Files with 200G to 280G are capable of abrading more finely, but cured products with high hardness can be abraded only little by little. Therefore, the files are preferably selected from those with 80G to 280G. Particular preferably, a file with a low G (e.g., 80G to 100G) is used at a portion far from the nail surface, and a file with a high G (e.g., 200G to 280G) is used for a portion close to the nail surface.

When the file includes a part that wears out after use, that part is preferably replaceable. However, this does not apply to the case where the material of that part has high durability.

The nail printer of the present embodiment includes a control unit (as circuitry). Preferably, the control unit includes a nail information detection controller that performs a nail information detection control. The nail information detection control is performed to grasp the residue of the cured product on the nail surface and to scrape off only the cured product without scraping the nail surface as much as possible. When the file is used to remove the cured product on the nail surface, the cured product can be removed effectively, but there is a risk that a portion other than the cured product and the nail surface will be scraped excessively. In the present embodiment, it is possible to prevent the nail from being abraded too much.

### Fifth Embodiment

Next, a nail printer according to another embodiment of the present invention is described in detail below. Hereinafter, descriptions of the same items as those in the above embodiments will be appropriately omitted.

The nail printer of the present embodiment includes a moisturizer applicator configured to apply a moisturizer to the nail. The use of the moisturizer applicator can save the user the trouble of applying the moisturizer by himself/herself. Application of the moisturizer makes it possible to moisturize the nails and fingers and reduce damage. In addition, durability of gels can be improved, and durability of the cured product can also be improved.

After removal of the cured product, the surface portion of the nail that has been in contact with the cured product is likely to be damaged or dried. Therefore, it is preferable that application of the moisturizer be performed after the removal of the cured product. By setting the apparatus so as to perform application of the moisturizer after removal of the cured product, forgetting to apply the moisturizer by the user can be avoided, and damage and drying of the nail can be prevented.

Examples of the moisturizer include, but are not limited to, oily substances such as petrolatum, vegetable oils, and animal oils, and proteins having high water retention ability such as hyaluronic acid and collagen. The moisturizer may be in a liquid form or a highly viscous semi-solid form such as hand creams.

How to apply the moisturizer can be appropriately selected. For example, the moisturizer may be discharged from an inkjet head to the nail or applied to the nail with a member capable of holding the moisturizer, such as a brush, cloth, non-woven paper, non-woven fabric, and absorbent cotton.

The moisturizer applicator is schematically illustrated in FIG. 9. A moisturizer applicator 60 may be an inkjet head or a member capable of holding a moisturizer, such as a brush. The moisturizer applicator 60 may be either fixed at a predetermined position or provided so as to be movable. The head unit 30 illustrated in FIG. 2 may have a head for discharging the moisturizer for serving as the moisturizer applicator 60.

Application of the moisturizer may be performed after removal of the cured product and before discharging of active energy rays. After application of the moisturizer, a process for removing the moisturizer may be performed. This process may be performed by wiping with the above-described cloth, non-woven paper, non-woven fabric, or absorbent cotton, or wiping with a member for removing a cured product. Theses members used for wiping may be impregnated with water or a remover. The remover may either contain or not contain a solvent such as acetone.

After application of the moisturizer, it is preferable that the nail be left for a predetermined time for increasing the amount of the moisturizer that permeates the nails and fingers. The time for leaving (also referred to as “application time”) can be changed as appropriate. The application time may be set by the apparatus in advance or may be set and/or changed by the user. The operation of the apparatus may be stopped after application of the moisturizer and restarted at the instruction by the user.

Since the time desired for moisturization may differ from user to user, it is preferable that the application time be arbitrarily set by the user's operation. The apparatus may include a storage unit configured to store the user's settings. The control unit may include a moisturizer application controller that performs a moisturizer application control to control the application conditions (e.g., amount, type, position) of the moisturizer and the wiping of the moisturizer.

### Sixth Embodiment

Next, a nail printer according to another embodiment of the present invention is described in detail below. Hereinafter, descriptions of the same items as those in the above embodiments will be appropriately omitted.

In the present embodiment, the nail printer includes a masking device configured to perform masking to mask a portion other than the nail. The masking is performed before discharge of the active energy ray curable composition to the nail. According to the present embodiment, adhesion of the active energy ray curable composition to a portion other than the nail is prevented, so that an artificial nail is formed more beautifully and the effect on the skin is reduced. In addition, it is possible to save the trouble of removing the cured product formed on a portion other than the target portion.

In attempting to discharge the active energy ray curable composition as close as possible to the skin part, the composition will adhere to the top of or boundary with the cuticle. In this case, the cured product will easily float from an end side thereof. In the present embodiment, the cured product is prevented from easily floating from the end side, finishing the nail more beautifully.

The masking device applies petrolatum, a semi-solid moisturizer, or the like, which can be wiped off later. In addition, the masking device may apply a liquid composition which can be peeled off from the skin after being dried, to the skin near the boundary with the nail. The masking device is used to prevent the active energy ray curable composition from being applied to a predetermined portion, and is not limited to those described above.

### Seventh Embodiment

Next, a nail printer according to another embodiment of the present invention is described in detail below. Hereinafter, descriptions of the same items as those in the above embodiments will be appropriately omitted.

This embodiment is a modification of the second and fourth embodiments including the removing device. The removing device of the present embodiment removes the cuticle. The removing device of the above-described embodiments are configured to remove the cured product formed on the nail, and that of the present embodiment is further configured to remove the cuticle. According to this embodiment, the nails can be made to look long and clean as the cuticles are removed. Further, the active energy ray curable composition is prevented from being applied onto the cuticle, preventing floating and peeling of the cured product.

The removing device of the present embodiment may remove the cuticle with, for example, a spatula-shaped member (e.g., pusher or the like), a file, or a cotton swab. The spatula-shaped member is sometimes referred to as a metal spatula, and preferably has a curved shape. In addition, a member such as a pick having a sharp tip can also be used. The member such as a metal spatula or a pick can be applied to the cuticle at an angle of 45 degrees or more with respect to the cuticle and pushed toward the base of the nail to remove the cuticle. It is preferable that the angle be 45 degrees or more. The member may be subjected to a reciprocation movement or a rotation movement.

It is preferable to apply a moisturizer to the cuticle before removing the cuticle. This makes it easier to remove the cuticle and reduces the effect on the skin. The size, shape, etc. of the member included in the removing device in the present embodiment can be appropriately selected. For example, when the member is a metal spatula, one having substantially the same size as the nail or one smaller/larger than the nail may be used.

### Functional Block Diagram

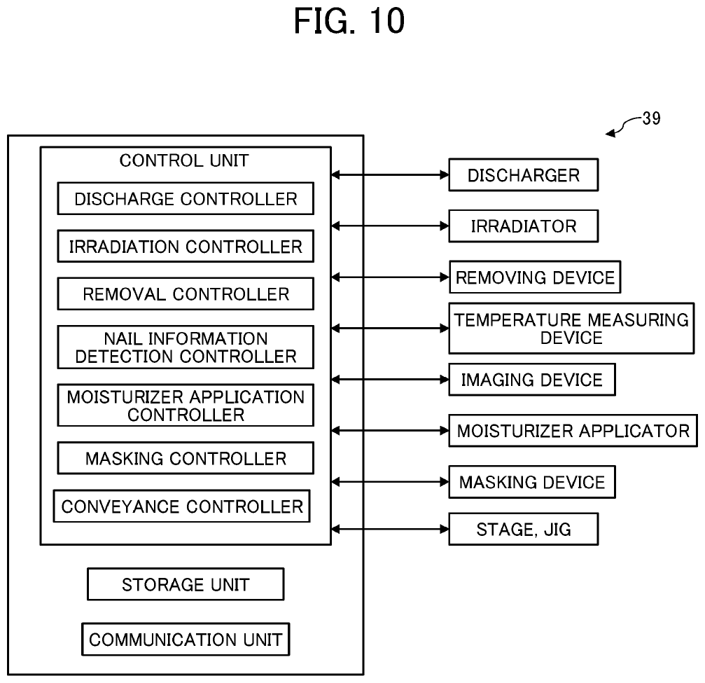

A functional block diagram of the nail printer according to the present embodiment is described below with reference to FIG. 10. The following description is only an example, and the present invention is not limited thereto.

The control unit can be appropriately selected. Specific examples thereof include a central processing unit (CPU). The control unit may vary the irradiation intensity.

As illustrated in FIG. 10, the control unit includes a discharge controller, an irradiation controller, a removal controller, a nail information detection controller, a moisturizer application controller, a masking controller, and a conveyance controller. The control unit needs not include all of these controllers. Also, the control unit may include other controllers not illustrated in FIG. 10.

The discharge controller may control the discharger to control the discharge amount, type, discharge position, etc. of the active energy ray curable composition. The type of the active energy ray curable composition is not particularly limited. As described above, the active energy ray curable composition may be varied in terms of the presence/absence of colorant and the types and contents of colorant and other components. Specific examples of the active energy ray curable composition include the artificial nail composition, the first composition, and the second composition.

The irradiation controller may control the irradiator to control the irradiation intensity, irradiation position, irradiation time, irradiation timing, and type of the active energy ray.

The removal controller may control the removing device to control determination on the presence or absence of a cured product, determination and change of the removing member, change of the removal portion, removal time, and removal timing. The removal controller may control the temperature measuring device or the imaging device.

The nail information detection controller may control the temperature measuring device and/or the imaging device so as to detect nail information.

The masking controller may control the masking device so as to perform a masking to prevent the active energy ray curable composition from adhering to a portion other than the target portion.

The conveyance controller may control the stage, the jig, and/or the carriage, to perform ascending, descending, and horizontal movement of the stage, movement of the jig, and scanning of the carriage. The conveyance controller may convey other devices.

The storage unit can be appropriately selected. Specific examples of the storage unit include, but are not limited to, random access memory (RAM), read only memory (ROM), and flash memory. The content stored in the storage unit is not particularly limited. Examples thereof include, but are not limited to, control conditions for each control. The control conditions may be either those determined at the time of designing the printer or those changed by the user. Further, the storage unit may store image information of the nail.

The communication unit can be appropriately selected. Specific examples thereof include, but are not limited to, an interface (I/F). The communication unit may accept instructions from the user, specifically, may enable the user to give instructions to each device and each member via the communication unit. In addition, the communication unit may accept information on what kind of an artificial nail to be produced from the user. In addition, the communication unit may accept settings for removal of the cured product, settings for application of the moisturizer, etc. from the user. Transmitting and receiving of data may be conducted using Bluetooth, WiFi, 5G, or the like.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims. Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

1. A nail printer comprising:
a discharger configured to discharge an active energy ray curable composition to a nail by an inkjet method;
an irradiator configured to irradiate the nail with an active energy ray; and
an irradiation intensity variator configured to vary an irradiation intensity of the active energy ray radiated from the irradiator.

2. The nail printer of claim 1, further comprising:
a temperature measuring device configured to measure a temperature of the nail in a non-contact manner,
wherein the irradiation intensity variator varies the irradiation intensity of the active energy ray radiated from the irradiator based on the temperature measured by the temperature measuring device.

3. The nail printer of claim 1, further comprising:
a jig configured to fix the nail.

4. The nail printer of claim 1, wherein the nail printer employs a serial method in which the discharger and the irradiator are movable.

5. The nail printer of claim 1, further comprising:
an imaging device adjacent to the irradiator, the imaging device configured to capture an image of the nail,
wherein the discharger discharges the active energy ray curable composition to a position of the nail, the position determined based on the image captured by the imaging device.

6. The nail printer of claim 1, wherein the active energy ray has a peak wavelength in a range of from 365 to 405 nm.

7. The nail printer of claim 1, wherein the irradiation intensity of the active energy ray radiated from the irradiator is from 10 to 500 mJ/cm².

8. The nail printer of claim 1, wherein the active energy ray curable composition has a stimulation index of 3.0 or less.

9. The nail printer of claim 1, further comprising:
a temperature measuring device configured to measure a temperature of the nail and a periphery of the nail in a non-contact manner,
wherein the discharger discharges the active energy ray curable composition to a position of the nail, the position determined based on a boundary between the nail and skin, the boundary determined based on the temperature measured by the temperature measuring device.

10. The nail printer of claim 1, further comprising:
a removing device configured to remove a cured product formed on the nail.

11. The nail printer of claim 10, wherein the removing device includes a removing member containing a removing agent, and the removing member is configured to come into contact with the nail.

12. The nail printer of claim 10, wherein the removing device further includes a file.

13. The nail printer of claim 1, further comprising:
a moisturizer applicator configured to apply a moisturizer to the nail.

14. The nail printer of claim 1, further comprising:
a masking device configured to mask a portion other than the nail.
